(19) United States
(12) Patent Application Publication
(10) Pub. No.: US 2006/0187424 A1
(43) Pub. Date: Aug. 24, 2006

(54) Projecting device and light module thereof

(76) Inventor: Ming-Dau Guo, Daya Township (TW)

Correspondence Address: RABIN & Berdo, PC, 1101 14TH STREET, NW, SUITE 500, WASHINGTON, DC, 20005, US

(21) Appl. No.: 11/358,295

(22) Filed: Feb. 22, 2006

(30) Foreign Application Priority Data
Feb. 24, 2005 (TW) 94105671

(51) Int. Cl. G03B 21/22; G03B 21/14

(52) U.S. Cl. 353/119

(57) ABSTRACT

A projecting device includes a housing, an optical engine and a light module. The optical engine is disposed inside the housing. The light module is against the optical engine, comprises a light source, a holder and a chamber. The holder used for positioning the light source is coupled to the optical engine. The chamber, used for receiving the light source, is coupled to the holder and detachably coupled to the housing.

This application claims the benefit of Taiwan application Serial No. 94105671, filed Feb. 24, 2005, the subject matter of which is incorporated herein by reference.

### BACKGROUND OF THE INVENTION

1. Field of the Invention

The invention relates in general to a projecting device, and more particularly to a projecting device whose light module may be mounted to or dismounted from the outer surface of the housing of the projecting device.

2. Description of the Related Art

The projecting device such as a projector is an electronic device widely used in the office, conference, household and school for discussion, presentation, teaching or entertainment purposes. The projecting device is to project the image onto a large screen for many people to view at the same time.

The projecting device mainly comprises three parts: a housing, a light module, and an optical engine. The light module and the optical engine are fixed inside the housing, and the light module is for generating the light. The optical engine guides the light, and further makes the light uniformed via beam splitting or converging. At last, the light projects and enlarges the image onto the screen via the lens. After a period of time, the projecting device needs to replace the light source in order to maintain the illuminating efficiency. During the conventional process of replacing the light source, the upper casing or the lower casing of the housing needs to be dismounted first. Then, tools like the screw driver may be used to separate the light module with the optical engine so as to dismount the used light source and replace it with a new one. On the contrary, if the user would like to assemble the parts back, the user needs to lock the light module with the optical engine, and then mounts the upper casing or lower casing onto the housing.

Worse than that, many projecting devices are mounted on the wall or the ceiling. The user needs to dismount the projecting device from the wall or the ceiling before the user can disassemble the projecting device and replace the light source, which is indeed very inconvenient and hazardous.

### SUMMARY OF THE INVENTION

It is therefore the object of the invention to provide a projecting device, facilitating the replacement of the light module, and simplifying the assembly between the light module, the optical engine and the housing.

According to an object of the invention, a projecting device comprising a housing, an optical engine, and a light module is provided. The optical engine is disposed inside the housing. The light module against the optical engine comprises a light source, a holder and a chamber. The holder used for positioning the light source is coupled to the optical engine. The chamber, used for receiving the light source, is coupled to the holder and detachably coupled to the housing.

According to another object of the invention, a light module disposed inside a projecting device is provided. The projecting device comprises a housing and an optical engine. A first side of the light module is coupled to an optical engine. A second side of the light module is detachably coupled to the outer surface of the housing. The light module comprises a light source, a holder and an optical engine. The holder positioned at the first side for positioning the light source is coupled to the optical engine. The chamber for receiving the light source is coupled to the holder.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a 3-D exploded diagram showing a part of a projecting device according to a preferred embodiment of the invention.

FIG. 1B is a top view of the projecting device in FIG. 1A.

FIG. 2A is a 3-D exploded diagram of an optical engine module viewed from a first view-angle.

FIG. 2B is a 3-D exploded diagram of an optical engine module viewed from a second view-angle.

FIG. 2C is a 3-D diagram showing an optical engine being connected to a light module.

### DETAILED DESCRIPTION OF THE INVENTION

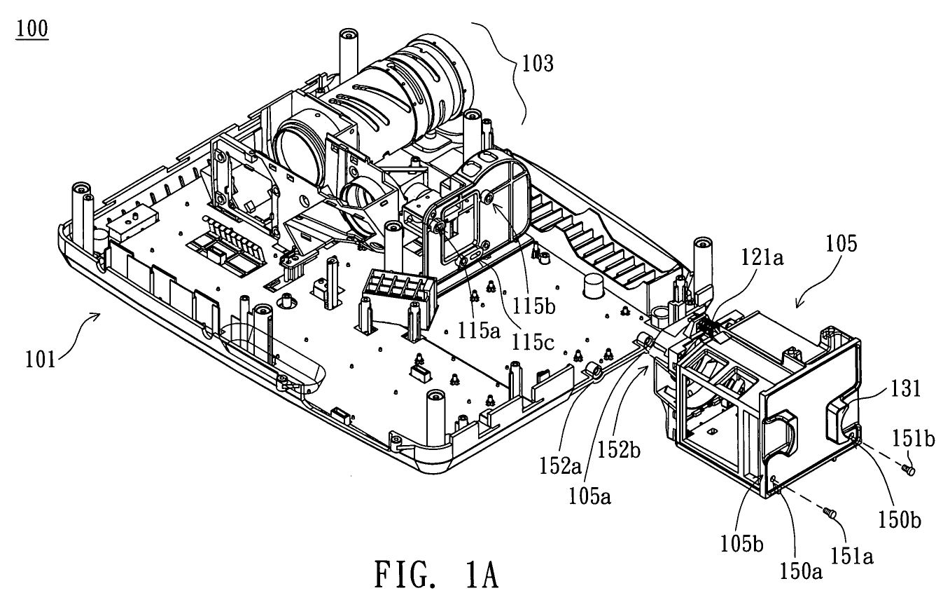

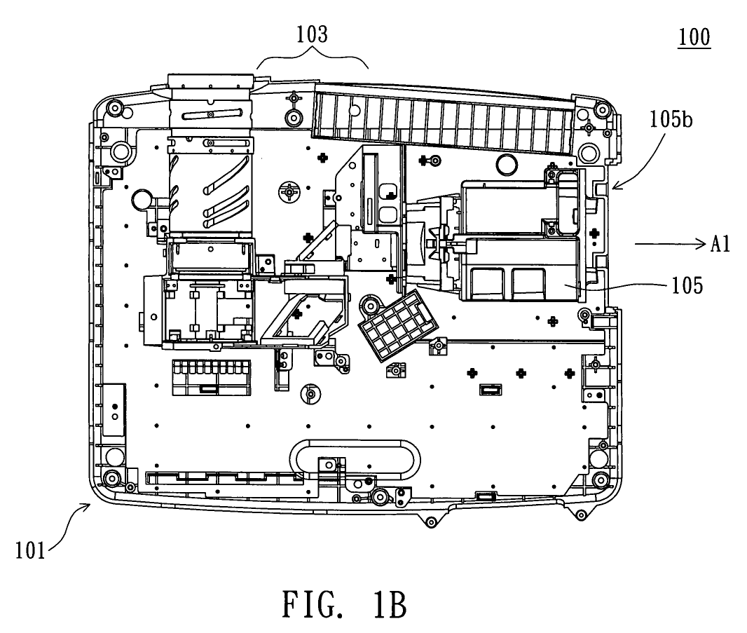

Referring to both FIG. 1A and FIG. 1B at the same time, FIG. 1A is a 3-D exploded diagram showing a part of a projecting device according to a preferred embodiment of the invention, while FIG. 1B is a top view of the projecting device in FIG. 1A. The projecting device 100 comprises a housing 101, an optical engine 103 and a light module 105. The optical engine 103 and the light module 105 are disposed inside the housing 101. The light module 105 comprises a first side 105a and a second side 105b. The first side 105a of the light module 105 is coupled to the optical engine 103 and the second side 105b thereof is detachably coupled to an outer surface of the housing 101. For example, when the user would like to withdraw the light module 105 from the housing 101 laterally (along direction A1 in FIG. 1), the user, first of all, needs to loosen two blocking pieces 151a and 151b, such as screws for instance, disposed between the outer surface of the housing 101 and the second side 105b of the light module 105. Then, the user would be able to withdraw the entire light module 105 laterally from the housing 101 by holding and moving the handle 131 disposed on the second side 105b of the light module 105 towards direction A1. In the present embodiment, via two holes 150a and 150b disposed on the second side 105b, the two blocking pieces 151a and 151b are respectively fixed in two screw holes 152a and 152b disposed on the outer surface of the housing 101.

It is noteworthy that the blocking piece may be a male or female piece that is commonly used by anyone who is skilled in the art, so the object of fixing the light module to be close to the outer surface of the housing may be achieved if a corresponding female or male piece is disposed on the housing.

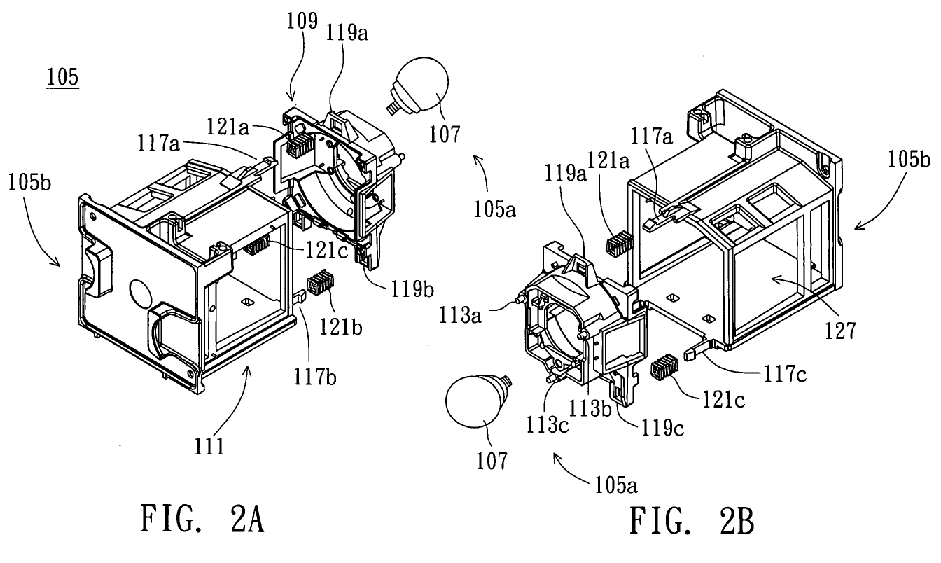

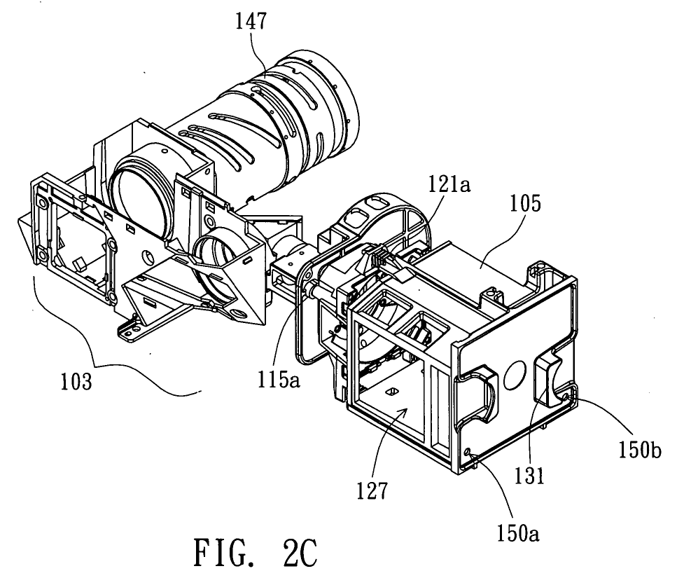

Referring to both FIG. 2A and FIG. 2B, FIG. 2A is a 3-D exploded diagram of an optical engine module viewed from a first view-angle, while FIG. 2B is a 3-D exploded diagram of an optical engine module viewed from a second view-angle. The light module 105 comprises a light source 107, a holder 109 and a chamber 111. The light source 107 may be a discharge lamp for instance. The holder 109 used for positioning the light source 107 is positioned at the first side 105a of the light module 105.

Refer to FIG. 1A, FIG. 2B and FIG. 2C at the same time. As shown in FIG. 2C, the holder 109 is coupled to the optical engine 103. In the present embodiment, the holder 109 has at least a first positioning portion, the optical engine 103 has at least a second positioning portion, and the first positioning portion is inserted to be coupled to the second positioning portion. As shown in FIG. 2B, the holder 109 may has three first positioning portions 113a, 113b and 113c. As shown in FIG. 1A, the optical engine 103 may has three second positioning portions 115a, 115b and 115c. The first positioning portions 113a˜113c in FIG. 1A are engaged with the second positioning portions 115a˜115c in FIG. 2B, so that the holder 109 is positioned in the optical engine 103. In the present embodiment, the first positioning portion 113a-113c are male pieces, while the second positioning portions 115a-115c are female pieces. However, other design enabling the first positioning portion to be engaged with the second positioning portion will do. For example, the second positioning portion is a male piece, while the first positioning portion is a female piece.

In the light module 105, the holder 109 has at least a first engaging portion and the chamber 111 has at least a second engaging portion. In the present embodiment, it is preferred that three first engaging portions 117a, 117b and 117c are uniformly distributed be correspondingly engaged with three second engaging portions 119a, 119b and 119c, so that the holder 109 and the chamber 111 are firmly assembled. Meanwhile, the light module 105 further has at least an elastic component disposed between the holder 109 and the chamber 111 so that the holder 109 is against the optical engine 103 tightly. For example, three elastic components 121a, 121b and 121c are disposed between the first engaging portion and the second engaging portion. The elastic components 121a, 121b and 121c, apart from enabling the holder 109 to be against the chamber 111 tightly, indirectly enables the entire light module 105 to be against the optical engine 103. In the present embodiment, the first engaging portion is a male piece and the second engaging portion is a female piece. Alternatively, the first engaging portion is also able to be engaged with the second engaging portion if the first engaging portion is a female piece and the second engaging portion is a male piece.

When the light module 105 is against the optical engine 103 tightly, the light generated by the light source 107 fixed on the light module 105 may precisely enter the optical engine 103. The optical engine 103 comprises a color wheel, a lens, digital micro-filming device (DMD) and a lens 147. After light is separated in red, blue, and green colors by the color wheel and focused by the lens, the variation of the contrast or brightness is generated by the digital micro-filming device, and then the light is projected and enlarged on a screen by the lens 147. Moreover, the light source always generates high heat when illuminating, a dissipation hole 127 is disposed on the light module to dissipate the heat.

The projecting device and the light module thereof disclosed in above embodiments of the invention facilitates the user to dismount the light module laterally and simplifies the assembly of the light module, the optical engine, and the housing via the design of locking the second side of the light module on the outer surface of the housing. Due to at least an elastic component disposed between the holder and the chamber, the holder abuts against the optical engine tightly, and the holder is firmly assembled with the chamber. Unlike the conventional practice which requires a tool to loosen the screws connecting the light module and the optical engine, the user may easily detach the entire light module from the optical engine simply by holding and moving the handle of the light module outwards. The replacement of the light source in the light module is made much easier to the user. In particular, according to the projecting device and the light module of the embodiments disclosed above, when replacing the light source of the projecting device mounted on the ceiling, the user may directly replace the light source laterally without dismounting the projecting device from the ceiling.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light module disposed inside a projecting device, the projecting device comprising a housing and an optical engine, a first side of the light module being coupled to the optical engine and a second side of the light module being detachably coupled to an outer surface of the housing, the light module comprising:
a light source;
a holder positioned at the first side for positioning the light source, wherein the holder is coupled to the optical engine; and
a chamber used for receiving the light source, wherein the light source is coupled to the holder.

2. The light module according to claim 1 further comprising an elastic component, disposed between the holder and the chamber such that the holder is against the optical engine tightly.

3. The light module according to claim 2, wherein the holder comprises a first engaging portion, the chamber comprises a second engaging portion, and the first engaging portion is engaged with the second engaging portion so that the holder and the chamber are assembled together.

4. The light module according to claim 2, wherein the holder comprises a first positioning portion, the optical engine comprises a second positioning portion, and the first positioning portion is coupled to the second positioning portion so that the holder and the optical engine are positioned and assembled together.

5. The light module according to claim 1, wherein the chamber further comprises a handle disposed at the second side of the light module.

6. The light module according to claim 1 further comprising a screw to lock the light module on the housing.

7. The light module according to claim 1, wherein the light source is a discharge lamp.

8. The light module according to claim 1, wherein the light module is inserted to be disposed inside the housing from a lateral side of the housing.

9. A projecting device, comprising:
a housing;
an optical engine, disposed inside the housing; and
a light module, being against the optical engine, wherein the light module comprises:
a light source;
a holder used for positioning the light source, wherein the holder is coupled to the optical engine;
a chamber used for receiving the light source, wherein the chamber is coupled to the holder and detachably coupled to the housing; and
an elastic component disposed between the holder and the chamber such that the holder is against the optical engine tightly.

10. The projecting device according to claim 9, wherein the holder comprises a first engaging portion, the chamber comprises a second engaging portion, and the first engaging portion is engaged with the second engaging portion so that the holder and the chamber are assembled together.

11. The projecting device according to claim 9, wherein the holder comprises a first positioning portion, the optical engine comprises a second positioning portion, and the first positioning portion is coupled to the second positioning portion so that the holder and the optical engine are positioned and assembled together.

12. The projecting device according to claim 9, wherein the chamber is detachably coupled to the outer surface of the housing.

13. The projecting device according to claim 12 further comprising a blocking piece for fixing the light module to be close to the outer surface of the housing.

14. The projecting device according to claim 9, wherein the chamber comprises a handle.

15. The projecting device according to claim 9, wherein the light module is inserted to be disposed inside the housing from a lateral side of the housing.
